(19) United States
(12) Patent Application Publication
(10) Pub. No.: US 2017/0189919 A1
(43) Pub. Date: Jul. 6, 2017

(54) SHOWERHEAD WATER DEFLECTOR

(71) Applicant: LIN MEI, EVANS, GA (US)

(72) Inventor: LIN MEI, EVANS, GA (US)

(21) Appl. No.: 15/396,693

(22) Filed: Jan. 2, 2017

Related U.S. Application Data
(60) Provisional application No. 62/378,870, filed on Aug. 24, 2016.
(60) Provisional application No. 62/275,233, filed on Jan. 5, 2016.

(51) Int. Cl. B05B 1/26; A47K 3/28; B05B 1/18

(52) U.S. Cl. CPC B05B 1/262; B05B 1/18; A47K 3/281

(57) ABSTRACT

The invention provides a showerhead water deflector effective for diverting showerhead water from its spray path. The showerhead water deflector includes a water-deflecting means coupled to a mounting device for attaching the water-deflector to a structure in the shower.

### CROSS-REFERENCE TO RELATED APPLICATIONS

This application claims priority to U.S. provisional application No. 62/275,233 filed Jan. 5, 2016, and U.S. provisional application No. 62/378,870, filed Aug. 24, 2016, the contents of which are incorporated herein by reference in their entirety.

### BACKGROUND

It is often the case that the first few moments after water is turned on at a water outlet such as a showerhead, tub spout, or other lower water outlet, the user is inundated with water of an uncomfortable temperature. This occurs because hot water heaters are often placed at a distance from water outlets, particularly in hotels, apartment buildings, and larger homes. The distances between hot water heaters and water outlets such as showers, tub spouts, and other lower water outlets allow water in the pipes that connect water heaters and water outlets to cool between uses. In addition, shower faucets are placed at positions that allow the user to easily adjust water temperature, whereas showerheads are usually placed at a higher position. The distances between temperature controllers and showerheads also lead to delays in water of a desirable temperature reaching showerheads.

### SUMMARY

The invention provides a water deflector that can direct water away from an individual in the shower until water that is at a comfortable or desirable temperature reaches the showerhead.

In one aspect, the invention provides a showerhead water deflector for diverting showerhead water from its spray path. The water deflector includes a water-deflecting member and a mounting device coupled to the water-deflecting member for attaching the water-deflecting member to a structure in the shower. The water-deflecting member includes an open water-deflecting surface from which water flows unimpeded in a direction determined by the tilt of the water-deflecting member when positioned in the spray path of the showerhead. The mounting device includes a body having a first end portion attached to the water-deflecting member and a second end portion configured for attaching to the structure in the shower.

In some embodiments, the select structure to which the second end portion of the mounting device is configured to attach is a showerhead, a shower arm, a shower wand, a shower bar, or a shower wall.

In some embodiments, the mounting device includes a hinge for attaching the water-deflecting member to the showerhead. In some embodiments, the hinge is a living hinge or a barrel hinge. In some embodiments, water deflecting member and living hinge are integrally formed.

In some embodiments, the mounting device includes a steel spring. In some embodiments, the mounting device includes a flexible, stayput, gooseneck metal tubing.

In some embodiments, the second end of the mounting device includes a suction cup.

In some embodiments, the mounting device includes a first rigid arm, one end of which is coupled to the water-deflecting member, the other end of which is rotatably coupled to a first end of a second rigid arm through a rotary hinge.

In some embodiments, the first rigid arm is rotatably attached to the water-deflecting member. In some embodiments, the water deflecting member and the first rigid arm are integrally formed.

In some embodiments, the second rigid arm includes a suction cup at a second end.

In some embodiments, the water-deflecting surface includes two or more ridges extending in parallel to form channels to facilitate unidirectional flow of water from the water deflector.

In some embodiments, the water-deflecting member has a flat structure.

In some embodiments, the water deflector has a water-deflecting surface with two or more ridges extending in parallel to form channels that facilitate water flow from the water deflector.

In some embodiments, the water-deflecting member includes a water-deflecting surface that is concave, and at least a portion of the side of the deflecting member is open.

In some embodiments, the water-deflecting surface is broader than the showerhead spray pattern at a distance no more than 8 inches downstream of the showerhead.

In another aspect, the invention provides a showerhead to which a water deflector of the invention is hinged so as to deflect showerhead water from its spray path when the water deflector is positioned in the spray path of the showerhead.

In some embodiments, the water deflector is hinged to the trim ring of the showerhead using a live hinge or a barrel hinge.

In some embodiments, the water deflector includes a water-deflecting surface that has two or more ridges extending in parallel to form channels that facilitate flow of water from the water deflector.

Unless otherwise defined, all technical and scientific terms used herein have the same meaning as commonly understood by one of ordinary skill in the art to which this invention belongs. In case of conflict, the present specification, including definitions, will control.

All patents and publications referenced or mentioned herein are indicative of the levels of skill of those skilled in the art to which the invention pertains, and each such referenced patent or publication is hereby incorporated by reference to the same extent as if it had been incorporated by reference in its entirety individually or set forth herein in its entirety. Applicants reserve the right to physically incorporate into this specification any and all materials and information from any such cited patents or publications.

Any feature or combination of features described herein are included within the scope of the present invention provided that the features included in any such combination are not mutually inconsistent as will be apparent from the context, this specification, and the knowledge of one of ordinary skill in the art. The materials, methods, and examples are illustrative only and not intended to be limiting. Although methods and materials similar or equivalent to those described herein can be used to practice the invention, suitable methods and materials are described below.

Other features and advantages of the invention will be apparent from the following detailed description and from the claims.

### DESCRIPTION OF THE DRAWINGS

FIGS. 1A-1B are schematic diagrams illustrating use of showerhead water deflectors 6 (1A) and 16 (1B) to divert water from showerhead 2 and 12, respectively, from their spray paths.

FIGS. 2A-2E are diagrams providing various views of water deflector 16 including: a top perspective view of shower head 16 with width w (2A) configured to accommodate the showerhead water spray angle Δ₁ of showerhead 12 (2B) and tilted at angle Δ₂ (2C, 2D) with respect to the horizon at distance d (2E).

FIGS. 3A-3G are vertical cross-sectional views of several embodiments of a water deflector of the invention including: a vertical cross-sectional view of water deflector 16 taken along a line perpendicular to its tilt represented by line tin FIGS. 2C & 2D (3A); a vertical cross-sectional view of water deflector 16 taken along a line parallel to its tilt (3B); a vertical cross-sectional views of water deflector 16-2, 116-1 and 116-2 (3C, 3D and 3E, respectively) taken along a line perpendicular to their tilt; and vertical cross-sectional views of two embodiments (2K, 2L) of water deflector 116-1 or 116-2 taken along a line parallel to their tilts.

FIGS. 4A-4D are schematic diagrams providing four views of showerhead 212 constructed with a water deflector of the invention including right side views in which built-in water-deflecting member 216 is in a deflecting position (4A) and in an open position (4B), as well as front views (4C, 4D) of the showerhead-water deflector combination in the deflecting position illustrated in FIG. 4A and in the open position illustrated in FIG. 4B, respectively.

FIGS. 5A-5D are schematic diagrams providing four views of showerhead 222 constructed with a water deflector of the invention including right side views in which built-in water-deflecting member 226 is in a deflecting position (5A) and in an open position (5B), as well as front views (5C, 5D) of the showerhead-water deflector combination in the deflecting position illustrated in FIG. 5A and in the open position illustrated in FIG. 5B, respectively.

FIGS. 6A-6D are schematic diagrams providing four views of showerhead 312 with shower arm-mounted water deflector 316 including two right side views in which shower arm-mounted water deflector 316 is in a deflecting position (6A) and in an open position (6B), as well as front views (6C, 6D) of water deflector 316 in the deflecting position illustrated in FIG. 6A and in the open position illustrated in FIG. 6B, respectively.

FIGS. 7A-7D are schematic diagrams providing four views of showerhead 322 with shower arm-mounted water deflector 326 including right side views in which shower arm-mounted water deflector 326 is in a deflecting position (7A) and in an open position (7B), as well as front views (7C, 7D) of water deflector 326 in the deflecting position illustrated in FIG. 7A and in the open position illustrated in FIG. 7B, respectively.

FIGS. 8A-8B are schematic diagrams providing two views of showerhead 312 with wall-mounted water deflector 416 including side views in which wall-mounted water deflector 416 is in a deflecting position (8A) and in a stowed position (8B).

FIGS. 9A-9B are schematic diagrams providing two views of showerhead 322 with wall-mounted water deflector 416 including side views in which wall-mounted water deflector 426 is in a deflecting position (9A) and in a stowed position (9B).

FIGS. 10A-10D are schematic diagrams providing four views of showerhead-mounted water deflector 516 including side views of water deflector 516 mounted on showerhead 312 in deflecting position (10A) and in open position (10B) and side views of water deflector 516 mounted on showerhead 322 in deflecting position (10C) and in open position (10D).

FIGS. 11A-11B are diagrams providing top views of showerhead-mounted water deflector 516 in open (11A) and closed configuration (11B).

FIGS. 12A-12H provide various views of showerhead water deflectors 616 and 716 including: a side view of water deflector 616 with gooseneck connector 616a mounted to wall 320 and adjusted to deflecting position beneath showerhead 322 (12A); a side view of water deflector 616 with gooseneck connector 616a mounted to shower bar 320b and adjusted to deflecting position beneath showerhead 322 (12B); a side view of water deflector 616 with gooseneck connector 616a mounted to shower arm 322a and adjusted to deflecting position beneath showerhead 322 (12C); a side view of water deflector 616 with gooseneck connector 616a mounted to shower arm 322b and adjusted to deflecting position beneath showerhead 322 (12D); a side view of water deflector 716 with gooseneck connector 716b mounted to showerhead 322 and adjusted to deflecting position beneath showerhead 322 (12E); a top view of water deflector 716 with gooseneck connector 716b extended to an open configuration (12F); a side view of water deflector 716 with gooseneck connector 716b in open configuration (12G); and a side view of water deflector 716 with gooseneck connector 716b adjusted to the closed configuration (12H).

FIGS. 13A-13D are diagrams providing side perspective views (13A, 13B) of showerhead-mounted water deflector 816 in deflecting position beneath showerhead 412 (13A) and in open position (13B), as well as top views of water deflector 816 in closed or deflecting configuration (13C) and open configuration (13D).

### DETAILED DESCRIPTION

The invention provides a showerhead water deflector configured to divert showerhead water from its spray path. As used herein, the term “spray path” refers to the path of water spraying from a showerhead. A water deflector of the invention can be used to divert water at uncomfortable temperature away from an individual standing beneath the showerhead or in its spray path until water that is at a comfortable or desirable temperature is dispensed from the showerhead. A showerhead water deflector of the invention includes a water-deflecting member coupled to a mounting device for attaching the water-deflecting member to a structure in the shower.

The water-deflecting member is configured to divert water emitting from a showerhead from its spray path in a direction determined by the tilt of the water-deflecting member. As used herein, the term “divert,” or “deflect” means to redirect the flow of water or alter the direction of water flowing from a source. Water from a showerhead is diverted or deflected from its spray path when it is redirected from its spray path to a different direction. The term “spray path,” as used in reference to a showerhead, means the path of water emitting unobstructed from a showerhead. The mounting device is configured to allow a user to mount the water deflector on a select structure in the shower so as to place the water-deflecting member in a select position with respect to the showerhead.

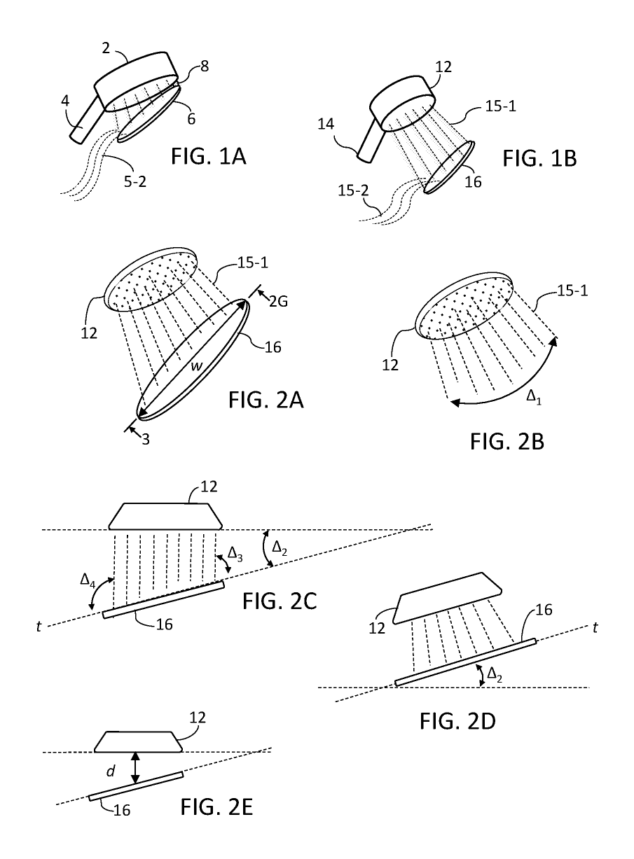

FIGS. 1A and 1B illustrate the use of two embodiments of a water deflector of the invention to divert showerhead water from its spray path. In FIG. 1A, water-deflecting member 6 is hinged to showerhead 2. Water deflecting member 6 is downwardly angled to divert water from showerhead 2 in the direction of its downward tilt. In FIG. 1B, water-deflecting member 16 is positioned in spray path 15-1 of showerhead 12 at a distance downstream from showerhead 12. It is also tilted so as to divert water downwardly and away from a position beneath showerhead 12 or its spray path. As such, water-deflecting members 6 and 16 can divert water from a user who may be standing beneath showerhead 2 and 12 or standing in their spray paths, respectively.

Water-Deflecting Member

A showerhead water deflector of the invention can have a rigid, semi-rigid or flexible water-deflecting member having sufficient structural rigidity to redirect showerhead water from its spray path as illustrated in FIGS. 1A-1B. The water-deflecting member can have any general shape or surface configuration effective to direct the flow of water as described. In general, the water-deflecting member can have a broad and shallow structure that is wider than it is thick, for example, a structure similar to a plate, valve or scoop. The water-deflecting member has a broad open surface that function as a water-deflecting surface from which water flows unimpeded in a direction determined by its tilt when the water-deflecting member is positioned in the spray path of the showerhead.

As used herein, the term “water-deflecting surface” refers to a broad open surface on the water-deflecting member that faces the showerhead and redirects water spraying from the showerhead. The water-water deflecting surface can be flat, curve, concave, include an elevated side, and/or include one or more ridges forming grooves that facilitate water flow in the direction of the grooves, so long as the water-deflecting surface is open to the flow of water.

As used herein, the term “open,” in reference to a water-deflecting surface or water-deflecting member, means the surface or member is uncovered or lacking an enclosure over the top and on some or all sides. As such, the water-deflecting surface is accessible to water from a showerhead when positioned in the spray path of the showerhead and enables the downward flow of water in the direction of tilt. A water-deflecting member also has an open water-deflecting surface if it is free of surface obstruction to water flow in at least one direction. For example, a water-deflecting member has an open water-deflecting surface if it includes one or more ridges forming parallel channels or grooves to facilitating water flow in the direction of the channels or grooves. A water-deflecting member also has an open water-deflecting surface if it includes an open side or edge, i.e. the water-deflecting member includes an elevated side portion extending partially around and an un-elevated, flat side or open edge, for example, an open edge that extends downward.

As used herein, the term “tilt,” in reference to the water-deflecting member refers to the angled position of the water-deflecting surface with respect to the horizontal. A water-deflecting member is tilted when its water-deflecting surface is at an angle with respect to the horizontal so as to enable downward flow of water. Thus, when tilted, showerhead water impacting the water-deflecting surface is redirected downward. Where the water-deflecting member includes one or more elevated sides, the water-deflecting member is tilted when it is positioned so its open side is downward relative to the rest of its body thereby enabling water to flow off the water-deflecting surface.

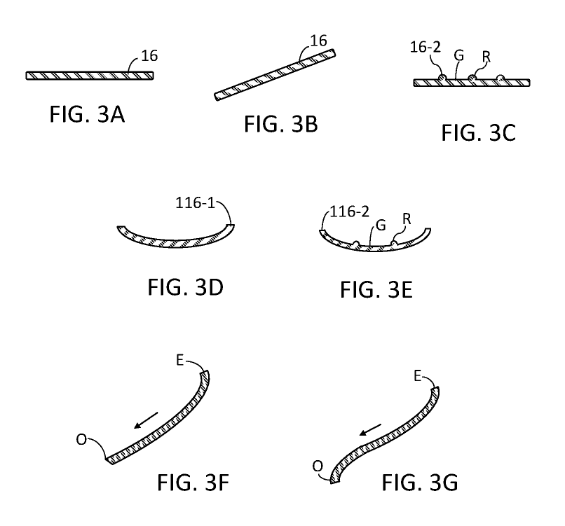

FIGS. 1A-1B and 2A-2E illustrate a generally flat water-deflecting member. Water-deflecting member 16 has a generally flat water-deflecting surface with a circular edge and a diameter or width represented by w (FIG. 2A). The generally flat structure of water-deflecting member 16 is illustrated in FIGS. 3A and 3B, which provides vertical cross-sectional views of water-deflecting member 16 along a line perpendicular to its tilt (FIG. 3A) and along a line parallel to its tilt (FIG. 3B). The tilt of water-deflecting member 16 is illustrated in FIGS. 2C & 2D, in which line t represents its tilt with respect to the horizontal as indicated by angle Δ₂.

FIG. 3D illustrates an example of a water-deflecting member of the invention that has a concave water-deflecting surface. FIG. 3D provides a cross-sectional view of water-deflecting member 116-1 along a line perpendicular to its tilt. FIGS. 3F and 3G vertical cross-sectional views of alternative embodiments of water-deflecting member 116-1 along a line parallel to its tilt. Water-deflecting member 116-1 is tilted as its open edge O is downwardly of the rest of its body. The concave structure and tilt of water-deflecting member 116-1 facilitate directional flow of water downward in the direction of the arrows.

FIGS. 3C and 3E illustrate examples of water-deflecting members that include one or more ridges forming two or more channels or grooves extending in the direction of tilt. FIG. 3C provides a cross-sectional view of water deflecting member 16-2 along a line perpendicular to its tilt. Water-deflecting member 16-2 includes three ridges R, forming grooves or channels G extending along its tilt to facilitate water flow downward in the direction of tilt. FIG. 3E provides a cross-sectional view of water deflecting member 116-2 along a line perpendicular to its tilt. Water-deflecting member 116-2 includes two ridges R, forming three grooves or channels G extending along its tilt to facilitate water flow downward in the direction of tilt.

FIGS. 3F-3G illustrate examples of a water-deflecting member that includes elevated side E and a lower open edge O. FIGS. 3F-3G provide vertical cross-sectional views of alternative embodiments along a line parallel to its tilt. The water-deflecting members are tilted so each of their open edge O is downward of the rest of the body of the water-deflecting member. Elevated side E and lower open edge O facilitate unidirectional flow of water downward along the tilt of the water-deflecting member as indicated by the arrows in FIGS. 3F and 3G.

The water-deflecting member can be sized to effectively receive and redirect water from the showerhead. Where the water-deflecting member is hinged to the showerhead as illustrated in FIG. 1A, the water-deflecting member can have a water-deflecting surface sized to approximate the spray pattern at the water-deflecting surface or at the showerhead outlet. Alternatively, the water-deflecting member can be sized larger than the spray pattern at the water-deflecting surface or at the showerhead outlet. The water-deflecting member can have a water-deflecting surface with an edge or shape approximating the edge or shape of the showerhead base or spray pattern. The water-deflecting member can have a regular or irregular edge or shape, for example, round, oval, square, rectangular or the shape of a regular or irregular polygon.

Where the water-deflecting member is positioned a distance from the showerhead as illustrated in FIGS. 1B and 2A-2E, the water-deflecting member can have a water-deflecting surface sized to approximate the spray pattern at the distance from the showerhead base at which the water-deflecting member is placed in diverting position so as to intercept and divert water emitting from the showerhead. The water-deflecting member can have water-deflecting surface sized larger than the showerhead spray pattern at a distance from the showerhead base at which the water-deflecting member is placed in diverting position so as to intercept and divert water emitting from the showerhead.

The water-deflecting member can have a water-deflecting surface configured for maximum contact with water from the showerhead. For example, as shown in FIG. 2A, water-deflecting member 16 is configured with width w that is at least about as wide as the spray pattern at the distance from the showerhead base at which the water-deflecting member is placed in diverting position. Typically, the width of the spray pattern, and thus, the width w of the water-deflecting member or its water-deflecting surface, can be based on spray angle Δ₁ (FIG. 2B) between about the center of the water-deflecting surface and the showerhead (FIG. 2E), and tilt angle Δ₂ between the deflecting member 16 and the horizontal (FIGS. 2C, 2D). The distance d between the water-deflecting surface and showerhead nozzle can be between about 0 to about 1 foot, for example, about 1, 2, 3, 4, 5, 6, 7, 8, 9, 10, 11 or 12 inches. Tilt angle Δ₂ can have a value great than 0 degrees and less than 90 degrees, for example, the tilt angle can be about 5, about 10, about 15, about 20, about 25, about 30, about 35 or about 40 degrees. The width can have any practical value between about 4 to about 5 inches to about 12 inches, for example, about 4, 5, 6, 7, 8, 9, 10, 11 ad 12 inches, or more than 12 inches. Typically, the farther the water-deflecting member is beneath the showerhead, the greater the width w of the water-deflecting member or water-deflecting surface.

Mounting Device

A showerhead water deflector includes a mounting device coupled to the water-deflecting member for attaching the water-deflecting member to a structure in the shower.

### The Mounting Device

A showerhead water deflector of the invention can be built-in to a showerhead, for example, directly hinged to a showerhead as illustrated in FIG. 1A. The deflector can be hinged to the showerhead trim ring, for example, or hinged to any other external part of the showerhead as convenient to position the water deflector in a tilted position in the showerhead spray path.

A showerhead water deflector of the invention can be mounted to the showerhead or to a structure in the shower or in the vicinity of a showerhead. In general, a water deflector can be mounted to any structure in the shower within arms reach of an individual. Non-limiting examples of structures in the shower to which a showerhead water deflector can be mounted include a showerhead, a shower arm, shower bar, or a portion of the shower wall.

Any mechanism known to those skilled in the art can be used to mount a showerhead water deflector of the invention to a structure in the shower such as a showerhead, shower arm, shower bar or wall, so long as the mechanism allows for adjusting the position the showerhead water deflector from an open or stow position to a diverting position or vice versa.

The term “open” or “stow” position, as used herein in reference to a showerhead water deflector or its deflecting member, means positioned outside the spray path of the showerhead so as to allow water to flow unhindered from the showerhead. A water-deflecting member or showerhead water deflector has no impact on the flow of water from a showerhead when in an open or stowed position. The term “diverting position,” as used herein means positioned in the spray path of the showerhead. When in a diverting position, the water-deflecting surface of the water-deflecting member can be oriented at an acute or obtuse angle relative at least a portion of the spray path as illustrated by Δ₃ and Δ₄ (FIG. 2C) to facilitate redirection or flow of water in a particular direction, i.e. downward in the direction of tilt. Thus, when in open or stow position, the deflecting member is outside the showerhead spray path and has no effect on water flow from the showerhead. When in diverting position, the deflecting member can divert water emitting from the showerhead in a direction away from the showerhead spray path and thus away from a user who may be standing in the showerhead spray path.

The mounting device can include any number of mounting arms and any number of hinges or joints as needed to facilitate positioning of the water-deflecting member. A mounting arm can be a rigid, semi-rigid or flexible metal or plastic rod, bar, hose, spring, or tubing secured to the water deflecting member, secured one to the other, or secured to a structure in the shower using any means of attachment or fastening known to those skilled in the art, including, for example, complementary external and internal threads, pin, screw, bolt, nut, adhesive, suction cup, clip, a cable or hose clamp or hook, bracket, a sliding or non-sliding shower bar-handset holder, and a snap-fit fastener such as a rod clip. A snap-fit fastening mechanism that can be used include, for example, those described in the following: Binotti et al., Self-locking Rod End Clip, U.S. Pat. No. 6,322,274 B1; Brown et al., Rod End Clip, U.S. Pat. No. 5,178,479; Rathbun, Snap Fit Rod and Fastener System, US20130072991 A1; and Rathbun, Rod Connector, U.S. Pat. No. 8,940,020 B2, the contents of which are incorporated by reference in their entirety. Additional rod to rod connectors that can be used include, for example, those described in the following: Richelsoph, Rod to Rod Connector with Load Sharing, U.S. Pat. No. 8,870,923; Lin et al., Transverse Rod Connector Clip, U.S. Pat. No. 6,783,526; Walraven, Rod Connector for Connecting Threaded Rods, US 20110262219 A1; and Chou, Rod Clip, U.S. Pat. No. 5,331,725, the contents of which are incorporated by reference in their entirety.

The mounting device can include one or more hinges or joints to allow rotary movement about an axis, linear movement along an axis, or multi-positional movement of a first water deflector component relative to a second. The term “hinge,” as used herein, refers to the mechanical components that form a joint, or the components for forming a joint, between two components that are moveable one with respect to the other. One or more hinges can be used to form a joint between a moveable or swinging arm and a second moveable or swinging arm of the mounting device, a fixed arm, the water-deflecting member to which it is joined, or the structure in the shower to which the water deflector is mounted. As such, the mounting device can be used to place the water-deflecting member in a deflecting position or in a stow or open position.

Non-limiting examples of joints that can be formed between components in a water deflector of the invention include knuckle joint, turnbuckle, pin joint, cotter joint, bolted joint, screw joint, or ball-and-socket joint. The joint can be a screw joint, turning joint, sliding joint, turning and sliding joint, linear joint, orthogonal joint, rotational joint, twisting joint, or revolving joint. Non-limiting examples of hinges that can be used include friction hinge, living hinge, ratchet hinge, adjustable angle hinge, detent hinge, and position-locking hinge. The hinge or joint can allow for infinite positioning or infinite positional adjustment of the movable or swinging component with respect to the fixed component. The hinge or joint can include multiple defined detents to enable rotary movement in about 5-degree, 10-degree, 15-degree, or 20-degree increments, for example, between adjoining components. The hinge or joint can include position-locking mechanism that allow for rigid lock points for travel of the moving component or swinging arm. Hinges having infinite positioning, detent positioning and position-locking mechanisms are known to those skilled in the art and available at MECHANISMS MARKET, St. Paul, Minn., http://www.mechanismsmarket.com (last visited Dec. 26, 2016).

The mounting device can include a rigid or semi-rigid swinging arm having a first end secured to a water-deflecting member and second end rotatably connected to a mounting arm, which is then secured to a shower structure such as a shower arm, a shower bar, a wall mount, or the shower wall using any attachment means known in the art. The mounting arm has a first end with which the swinging arm forms a moveable joint, and a second end that is fixed to the shower arm, shower bar, wall mount, or shower wall using, for example, shower mount, a handset holder or suction cup.

The mounting device can include a series of linkages such as rhombus or scissor linkages that form an extendable or deployable linkage secured to a shower arm or shower bar at one end and to a water-deflecting member on the other end.

The mounting device can include tubing formed by a flexible metal spring such as a stay-put gooseneck tubing having a first end attached to the water-deflecting member and a second end mounted to a structure in the shower such as a shower arm, shower bar, shower wall mount, or shower wall using mechanisms known to the art. Flexible metal tubings such as flexible stayput gooseneck tubings are known to those skilled in the art. See, for example, UNIPRISE INTERNATIONAL INCORPORATED, Flexible Metal Tubing, available at http://tubing.flexible-gooseneck. com/viewitems/all-categories/flexible-metal-tubing-2? (last visited Dec. 26, 2016); WHITEHOUSE FLEXIBLE TUBING LTD, Stayput/Gooseneck Tubing, available at http://www.flexible-tubing.com/product-ranges/metallic-tubing/stayput-gooseneck-tubing/ (last visited Dec. 26, 2016); and WHITEHOUSE FLEXIBLE TUBING LTD., Product Catalogue, Stayput & Coolant Hoses, Page 39, available at http://www.flexible-tubing.com/files/8314/6036/5273/Whitehouse catalogue FINAL 09.04.16.pdf (last retrieved Dec. 26, 2016). Flexible metal tubings effective for use to mount a water deflector to a structure in the shower include the following:

A water deflector of the invention, i.e., water-deflecting member and/or mounting device, can be constructed of any rigid, semi-rigid or flexible material known in the art. It can be constructed of the same material as the showerhead or other fixtures including, for example, aluminum, polished chrome, brushed chrome, polished nickel, brushed nickel, hammered nickel, stainless steel, bronze, brushed bronze, satin bronze, oil-rubbed bronze, brass, chrome plated brass, nickel plated brass, electroless nickel plated brass, polished brass, copper, plastic or any combination thereof. Additional examples include, without limitation, polyethylene terephthalate (PET), high density polyethylene (HDPE), polyvinyl chloride (PVC), low density polyethylene (LDPE), polypropylene (PP), polystyrene (PS), polyamide (PA), polycarbonate, copolyester, polylactide, polyurethanes, polyesters, epoxy resins, phenolic resins, wood, bamboo, or any combination thereof. A water deflector of the invention also can be constructed of carbon steel, high speed steel, zinc coated steel, nickel coated steel, galvanized steel, talcum filled polypropylene, glassfibre reinforced PP, high density polyethylene, polyvinylidenefluoride (PVDF), polytetrafluorethylene (PTFE), PTFE with 25% glassfibers, acetalic resin (POM), vitron, synthetic rubber (NBR), ceramic, ruby insert, cast iron, titanium, wood, bamboo, or any combination thereof.

Specific embodiments of the invention are described in the following examples, which do not limit the scope of the invention described in the claims.

### EXAMPLES

### Example 1

### Showerhead with Built-in Water Deflector

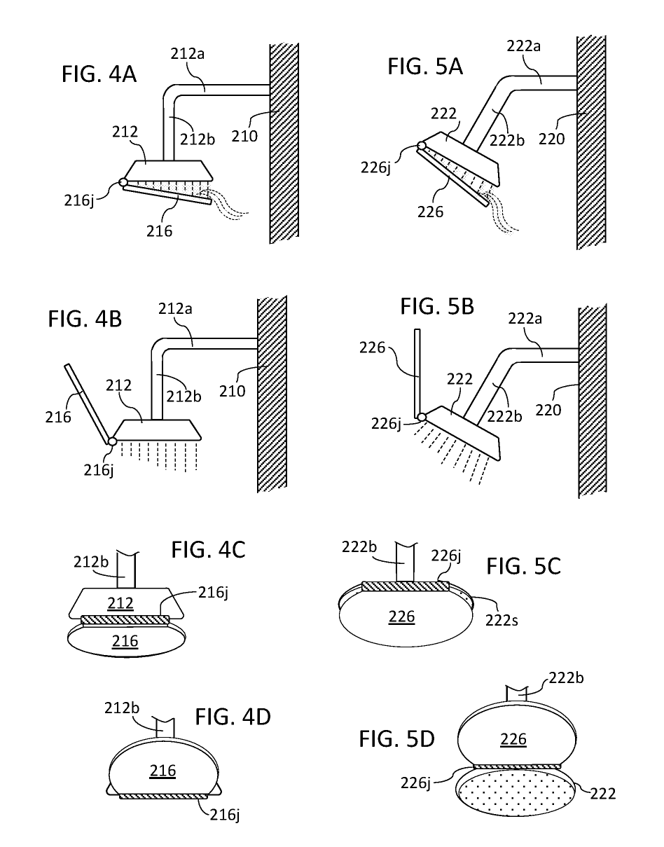

FIGS. 4A-4D and 5A-5D illustrate showerheads with built-in water deflectors.

FIGS. 4A-4B provide side views of water-deflector 216, which is pivotably attached to showerhead 212 through a rotary hinge at joint 216j. The rotary hinge allows water-deflecting member 216 to pivot about joint 216j to the deflecting position illustrated in FIG. 4A or to the open position illustrated in FIG. 4B. FIGS. 4C-4D provide front views of showerhead 212 with hinged water-deflecting member 216 in the deflecting and open positions, respectively.

FIGS. 5A-5B provide side views of water-deflector 226, which is pivotably attached to showerhead 222 through a similar rotary hinge at joint 226j. The rotary hinge allows water-deflecting member 226 to pivot about joint 226j to the deflecting position illustrated in FIG. 5A or to the open position illustrated in FIG. 5B. FIGS. 5C-5D provide front views of showerhead 222 with hinged water-deflecting member 226 in the deflecting and open positions, respectively.

### Example 2

### Shower Arm Mounted Water Deflector

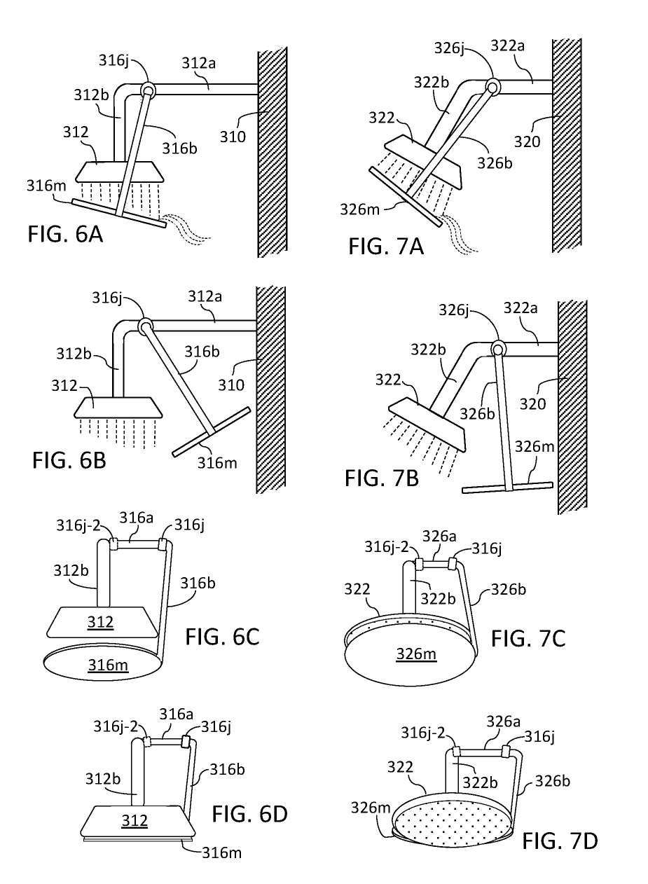

FIGS. 6A-6D and FIGS. 7A-7D illustrate two embodiments of the invention in which a water deflector is mounted to a shower arm.

FIGS. 6A-6D provide side and front views, respectively, of water deflector 316, which includes water-deflecting member 316m attached to swinging arm 316b, which in turn is pivotably attached to one end of fixed mounting arm 316a (FIGS. 6C, 6D) through a rotary hinge at joint 316j. Fixed mounting arm 316a is secured at its other end to a convenient position on shower arm 312a using a rod clip. Alternatively, fixed mounting arm 316a can be secured using a similar mechanism to a convenient position on shower arm 312b (not shown). The rotary hinge at 316j allows water-deflecting member 316m attached to swinging arm 316b to swing to the deflecting position illustrated in FIGS. 6A and 6C, or the stow position illustrated in FIGS. 6B and 6D. FIGS. 6C-6D provide front views of showerhead 312 with water-deflecting member 316m in the deflecting and stow positions, respectively.

In an alternative embodiment of water deflector 316 (not shown), water-deflecting member 316m is attached to rotating arm 316 formed by adjoining arm sections 316a and 316b. Rotating arm 316 is movably attached at a convenient location on shower arm 312a or 312b through a ball-and socket hinge at joint 316j-2 shown in dotted lines in FIGS. 6C-6D.

FIGS. 7A-7D provide side and front views, respectively, of water-deflector 326, which includes water-deflecting member 326m attached to swinging arm 326b, which in turn is pivotably attached to one end of fixed mounting arm 326a (FIGS. 7C, 7D) through a rotary hinge at joint 326j. Fixed mounting arm 326a is secured at its other end to a convenient position on shower arm 322a through a rod clip. Alternatively, fixed mounting arm 326a can be secured using a similar mechanism to a convenient position on shower arm 322b (not shown). The rotary hinge at 326j allows water-deflecting member 326m attached to swinging arm 326b to swing to the deflecting position illustrated in FIGS. 7A and 7C, or the stow position illustrated in FIGS. 7B and 7D. FIGS. 7C-7D provide front perspective views of showerhead 322 from beneath showerhead 322 in which water-deflecting member 326m is in the deflecting and stow positions, respectively.

In an alternative embodiment of water deflector 326 (not shown), water-deflecting member 326m is attached to rotating arm 326 formed by adjoining arm sections 326a and 326b. Rotating arm 326 is movably attached at a convenient location on shower arm 322a or 322b through a ball-and socket hinge at joint 316j-2 shown in dotted lines in FIGS. 7C-7D.

### Example 3

### Wall-Mounted Water Deflector

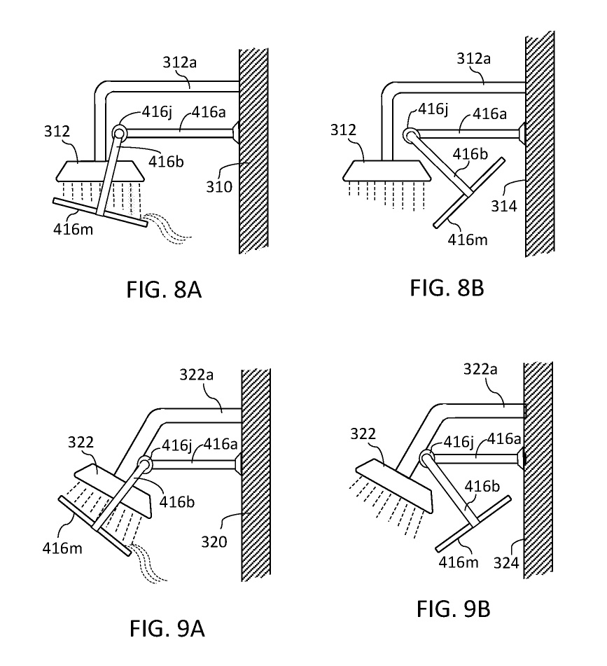

FIGS. 8A-8B and 9A-9B provide side views of wall-mounted water deflector 416, which includes water-deflecting member 416m attached to swinging arm 416b, which in turn is pivotably attached to one end of fixed mounting arm 416a using, for example, a rotary hinge at joint 416j. Fixed mounting arm 416a is secured at its other end to a convenient position on shower wall 310 or 314 using any means known in the art including, for example, through use of a suction cup. Alternatively, fixed mounting arm 416a can be secured to a convenient position on a vertical or horizontal shower bar (not shown) using a rod clip or showerhead holder. The rotary hinge at joint 416j allows water-deflecting member 416m attached to swinging arm 416b to swing to the deflecting position illustrated in FIGS. 8A and 9A or the stow position illustrated in FIGS. 8B and 9B.

### Example 4

### Water Deflector with Showerhead Bracket

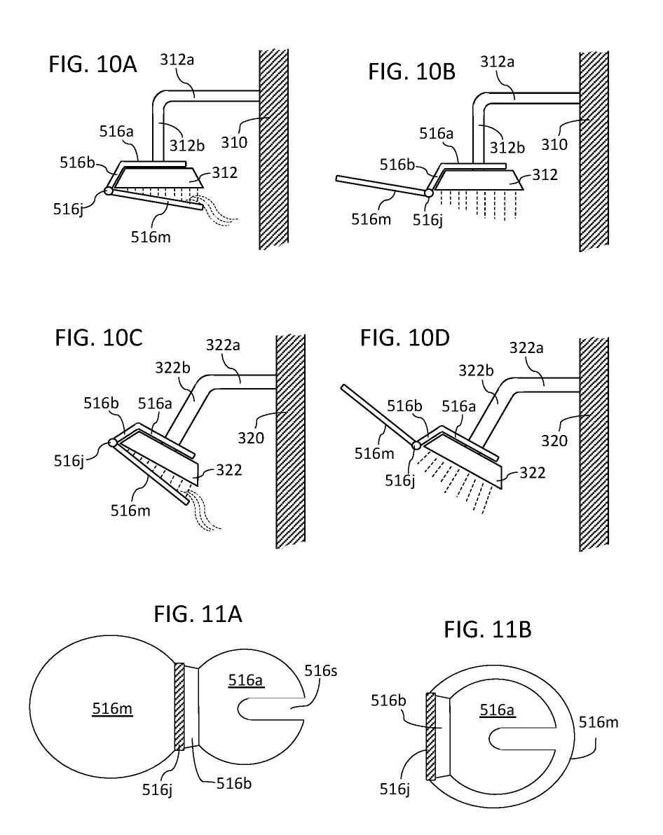

FIGS. 10A-10D provide side views of water deflector 516 removably mounted to showerhead 312 (FIG. 9A-9B) and to showerhead 322 (FIG. 10C-10D). Water deflector 516 includes water-deflecting member 516m, which is connected to mounting portion 516b through a rotary hinge at joint 516j. Mounting portion 516b adjoins mounting portion 516a, which is configured with slot 516s (FIGS. 11A, 11B) to accommodate shower arm 312b and 322b when mounting portion 516a is positioned over the top of showerhead 312 and 322 (FIGS. 10A-10D). Mounting portions 516a and 516b are dimensioned to overlay the top and side portions of showerheads 312 and 322, respectively, the portions being sized and proportioned to lay flush with the surface of showerhead 312 and 322 thereby enabling water-deflecting member 516m to hang securely from showerheads 312 and 322 in the deflecting position illustrated in FIGS. 10A and 10C and in the open position illustrated in FIGS. 10B and 10D. In an alternative embodiment, water-deflecting member 516m and mounting portion 516b can adjoin through a live hinge to form joint 516j.

### Example 5

### Water Deflectors with Flexible Gooseneck Mounting Arm

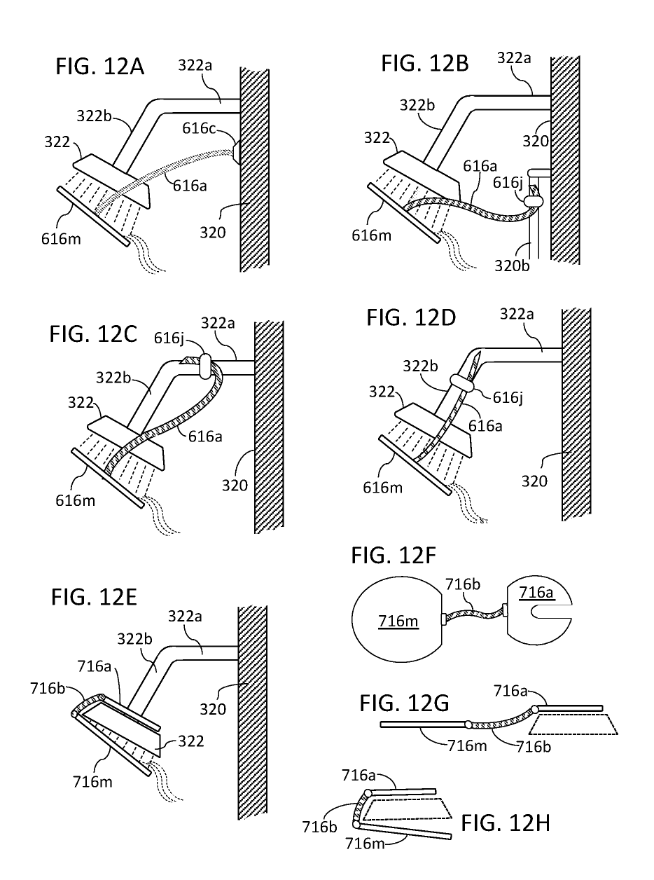

FIGS. 12A-12H provide various views of water deflectors with flexible gooseneck mounting arms. Water deflector 616 includes water-deflecting member 616m attached to one end of flexible stayput gooseneck mounting arm 616a. The other end of stayput gooseneck mounting arm 616a can be secured to a shower wall (FIG. 12A), a shore bar (FIG. 12B), a portion of the shower arm (FIGS. 12C, 12D), or to the showerhead (FIG. 12E) using means known in the art. FIG. 12A provides a side view of showerhead water deflector 616 in which the water-deflecting member 616m is attached to flexible stayput gooseneck mounting arm 616a that is mounted to shower wall 320 through suction cup 616c. FIG. 12B provides a side view of showerhead water deflector 616 in which the water-deflecting member 616m is attached to flexible stayput gooseneck mounting arm 616a that is mounted to vertical shower bar 320b through showerhead holder or clamp 616j. FIG. 12C provides a side view of showerhead water deflector 616 in which the water-deflecting member 616m is attached to flexible stayput gooseneck mounting arm 616a that is mounted to a potion of shower arm 322a through showerhead holder or clamp 616j. FIG. 12D provides a side view of showerhead water deflector 616 in which the water-deflecting member 616m is attached to flexible stayput gooseneck mounting arm 616a that is mounted to a portion of shower arm 322b through showerhead holder or clamp 616j. FIG. 12E provides a side view of showerhead water deflector 716 in which the water-deflecting member 716m is attached to one end of flexible stayput gooseneck mounting arm 716b, the other end of which is attached to water deflector mounting portion 716a configured to lay over the top of shower head 322 to allow water deflector 716 to hang from shower head 322.

FIG. 12F provides a top view of water deflector 716 in which flexible stayput gooseneck mounting arm 716b is extended to achieve an open configuration. FIG. 12G provides a side view of water deflecting 716 in which flexible stayput gooseneck mounting arm 716b is extended to achieve an open configuration. FIG. 12H provides a contrasting side view of water deflecting 716 in which flexible stayput gooseneck mounting arm 716b is bent to achieve a closed configuration in which mounting portion 716a extends over the top of a showerhead, while water-deflecting member 716m hangs at an angle beneath the showerhead. In the closed configuration, the angle or tilt of water-deflecting member 716m with respect to the horizontal allows water-deflecting member 716m to redirect water from the showerhead downward and away from the spray path of the showerhead. Thus, flexible stayput gooseneck mounting arm 616a and 716b can be adjusted to position the attached water-deflecting member in a select position, their rigidity or stiffness providing support and holding the attached water-deflecting member in place.

In an alternative embodiment, not shown, water deflector 616 can be secured to a showerhead such as showerhead 322 simply by wrapping flexible stayput gooseneck mounting arm 616 around shower arm 322b and forming a knot above showerhead 322. Showerhead water deflector 616 can then be adjusted to a desired position, e.g. water-deflecting member 616m can be adjusted to a deflecting or stow position, the rigidity or stiffness of flexible stayput gooseneck mounting arm 616 allowing the attached water-deflecting member to remain in place.

### Example 6

### Water Deflector with Showerhead Bracket

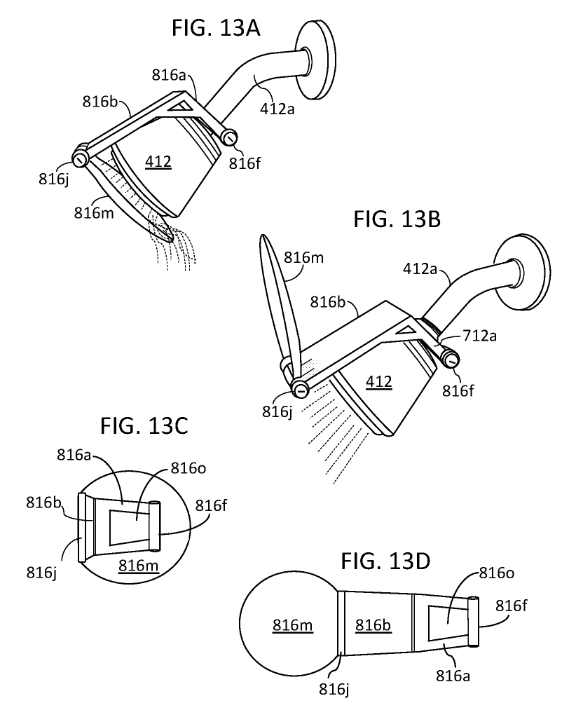

FIGS. 13A-13B provide side views of water deflector 816 removably mounted to showerhead 412 (FIGS. 13A-13B). Water deflector 816 includes water-deflecting member 816m, which is connected to mounting portion 816b through a rotary hinge at joint 816j. Mounting portion 816b adjoins mounting portion 816a, which is configured with central opening 816o (FIGS. 14A, 14B) to accommodate shower arm 412a. Mounting portions 816a and 816b are dimensioned to lay over the top and side portions of showerhead 412, respectively, and fastener 816f, which can include a pin, nut, and/or screw as known in the art, secures mounting portion 816a to showerhead 412, thereby enabling water-deflecting member 816m to hang securely from showerhead 412 in the deflecting position illustrated in FIG. 13A or in the open position illustrated in FIG. 13B. In an alternative embodiment, water-deflecting member 816m and mounting portion 816b can adjoin through a live hinge to form joint 816j. FIGS. 13C and 13D provide top views of water deflector 816 in the closed or diverting configuration (13C) and in the open configuration (13D).

### OTHER EMBODIMENTS

As used herein and in the claims, the singular forms “a,” “an,” and “the” include the plural unless the context clearly dictates otherwise. As used herein, the term “about” in reference to a numeric value means within 10% of the numeric value.

The invention has been described broadly and generically herein. Each narrower species and subgeneric groupings falling within the generic disclosure form part of the invention.

The present application is not to be interpreted as limited to the specific examples, embodiments or methods specifically disclosed. Specific embodiments and methods described herein are exemplary and not intended as limitations on the scope of the invention. Other objects, aspects, and embodiments that occur to those skilled in the art on consideration of this specification are encompassed within the spirit of the invention, as substitutions and modifications may be made to the invention disclosed herein without departing from the scope and spirit of the invention. The invention described herein may be practiced in the absence of any element or limitation that is not specifically disclosed as essential. The methods and processes described herein may be practiced in differing orders of steps and are not necessarily restricted to the orders of steps described or claimed herein.

What is claimed is:

1. A showerhead water deflector for diverting showerhead water from its spray path, the water deflector comprising a water-deflecting member and a mounting device coupled to the water-deflecting member for attaching the water-deflecting member to a structure in the shower, wherein:
(a) the water-deflecting member comprises an open water deflecting surface from which water flows unimpeded in a direction determined by the tilt of the water-deflecting member when positioned in the spray path of the showerhead; and
(b) the mounting device comprises a body having a first end portion attached to the water-deflecting member and a second end portion configured for attaching to the structure in the shower.

2. The water deflector of claim 1, wherein the select structure to which the second end portion of the mounting device is configured to attach is a showerhead, a shower arm, a shower wand, a shower bar, or a shower wall.

3. The water deflector of claim 1, wherein the mounting device comprises a hinge for attaching the water-deflecting member to the showerhead.

4. The water deflector of claim 3, wherein the hinge is a living hinge or a barrel hinge.

5. The water deflector of claim 4, wherein the water deflecting member and living hinge are integrally formed.

6. The water deflector of claim 1, wherein the mounting device comprises a steel spring.

7. The water deflector of claim 1, wherein the mounting device comprises flexible stayput gooseneck metal tubing.

8. The water deflector of claim 7, wherein the second end of the mounting device comprises a suction cup.

9. The water deflector of claim 1, wherein the mounting device comprises a first rigid arm, one end of which is coupled to the water-deflecting member, the other end of which is rotatably coupled to a first end of a second rigid arm through a rotary hinge.

10. The water deflector of claim 9, wherein the first rigid arm is rotatably attached to the water-deflecting member.

11. The water deflector of claim 9, wherein the water deflecting member and the first rigid arm are integrally formed.

12. The water deflector of claim 9, wherein the second rigid arm comprises a suction cup at a second end.

13. The water deflector of claim 1, wherein the water-deflecting surface comprises two or more ridges extending in parallel to form channels to facilitate flow of water from the water deflector.

14. The water deflector of claim 1, wherein the water-deflecting member comprises a flat structure.

15. The water deflector of claim 14, wherein the water deflector comprises a water-deflecting surface that comprises two or more ridges extending in parallel to form channels that facilitate unidirectional flow of water from the water deflector.

16. The water deflector of claim 1, wherein the water-deflecting member comprises a water-deflecting surface that is concave, and wherein at least a portion of the side of the deflecting member is open.

17. The water deflector of claim 1, wherein the water-deflecting surface is broader than the showerhead spray pattern at a distance no more than 8 inches downstream of the showerhead.

18. A showerhead comprising the water deflector of claim 1 hinged to the showerhead so as to deflect showerhead water from its spray path when the water deflector is positioned in the spray path of the showerhead.

19. The showerhead of claim 18, wherein the water deflector is hinged to the trim ring of the showerhead using a live hinge or a barrel hinge.

20. The showerhead of claim 18, wherein the water deflector comprises a water-deflecting surface that comprises two or more ridges extending in parallel to form channels that facilitate unidirectional flow of water from the water deflector.
